(19) United States
(12) Patent Application Publication
(10) Pub. No.: US 2011/0225524 A1
(43) Pub. Date: Sep. 15, 2011

(54) Multi-Touch Editing in a Graphical Programming Language

(76) Inventor: Christopher G. Cifra, Austin, TX (US)

(21) Appl. No.: 12/720,966

(22) Filed: Mar. 10, 2010

(51) Int. Cl. G06F 3/048; G06F 3/041

(52) U.S. Cl. 715/763; 345/173

(57) ABSTRACT

System and method for editing a graphical program. A graphical program is displayed on a display device. Multi-touch input is received to a multi-touch interface, where the multi-touch input specifies an edit operation in the graphical program. The edit operation is performed in the graphical program in response to the multi-touch input, and the edited graphical program is displayed on the display device.

### FIELD OF THE INVENTION

The present invention relates to the field of graphical programming, and more particularly to a system and method for multi-touch editing in a graphical programming language.

### DESCRIPTION OF THE RELATED ART

Graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

Computer touchscreens and touchpads have become increasingly popular for interacting with applications without using a computer keyboard or mouse, such as, for example, entering user input at checkout counters, operating smart phones, playing games on portable game machines, and manipulating files on a computer “desktop”. Multi-touch screens or pads (and supporting software/firmware) facilitate multiple simultaneous points of contact, referred to as touchpoints, allowing for more complex operations to be performed, such as shrinking or expanding an onscreen display by “pinching” or “reverse pinching”.

However, prior art uses of touch functionality with regard to computer operations have typically been limited to gross object manipulation such as moving or otherwise organizing computer folders and files, launching programs, selecting menu items, and so forth.

### SUMMARY OF THE INVENTION

Various embodiments of a system and method for multi-touch editing in a graphical programming development environment are presented below.

A graphical program may be displayed on a display device, e.g., of a computer system. The graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. As noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program. The graphical programming development environment may be configured to support multi-touch editing operations, as will be described in more detail below.

Multi-touch input may be received to a multi-touch interface, wherein the multi-touch input specifies an edit operation in the graphical program. As used herein, “multi-touch input” refers to user input to a multi-touch interface where there are multiple touchpoints active at the same time. In other words, the user may cause, utilize, or employ multiple simultaneous points of contact on the multi-touch interface. Note that the multi-touch interface may be a touch pad or a touch screen, as desired. In other words, the multi-touch interface may be or include a computer touch-pad and/or a computer touch-screen. Exemplary multi-touch input and edit operations are provided below.

The edit operation may be performed in the graphical program in response to the multi-touch input. In other words, the edit operation specified by the multi-touch input may be performed in or on the graphical program, thereby generating an edited graphical program. In some embodiments, an indication of the multi-touch input may be displayed in the graphical program before or as the edit operation is performed. For example, each touchpoint may be indicated on the screen, e.g., by an icon, e.g., a dot, and whose size, color, or style, may be adjustable. Additionally, in some embodiments, additional graphical indicators related to the multi-touch input may be displayed. For example, in one embodiment, when the multiple touchpoints are first activated, e.g., prior to any movement, or possibly as the movement occurs, an indication of the associated edit operation may be displayed, e.g., arrows indicating movement options for moving the touchpoints. In one illustrative embodiment, in a multi-touch pinching or reverse pinching input, once the touchpoints are active, but prior to any movement, radial double headed arrows may be displayed at each touchpoint, indicating that the touchpoints may be moved inwardly or outwardly to contract or expand an element or other portion of the program. Similarly, double headed arrows perpendicular to the radials, i.e., may indicate a rotational option or effect. In other words, such indicators may indicate movement options and/or edit effects resulting from such movements. The indicators may displayed in any number of ways, e.g., as dashed lines, with or without arrow heads, animation, etc., as desired.

The edited graphical program may then be displayed on the display device. Said another way, the result of the edit operation may be indicated in the displayed graphical program.

In various embodiments, the multi-touch input may include any of various multi-touch operations, and the specified edit operation may be or include any of various graphical program edit operations. Below are described various exemplary multi-point inputs and graphical program edit operations, although it should be noted that the multi-point inputs and edit operations presented are exemplary only, and are not intended to limit the multi-point inputs and edit operations to any particular set of inputs and operations. Moreover, it should be further noted that any of the described multi-point inputs and edit operations may be used in any of various combinations as desired, and further, that any other multi-point inputs or edit operations are also contemplated. In other words, embodiments of the invention may include any of various types of multi-touch inputs (including sequences of such inputs) and associated graphical program edit operations.

In some embodiments, the multi-touch input may be context sensitive, where the edit operation is based at least partially on a target graphical program element or region to which the multi-touch input is applied. In other words, the edit operation invoked by the multi-touch input may depend on the particular element(s) of the graphical program to which the input is applied, including blank space in the program. Thus, for example, tapping two graphical program elements simultaneously may invoke a wiring operation to connect the two elements, whereas tapping a single graphical program element may simply select that element, e.g., for a subsequent operation. Further, tapping a graphical program element that is a sub-program node (that represents a sub-program, called a sub-VI in LabVIEW), may cause the sub-program represented by this element to “open up” or be displayed. In this manner, a given multi-touch input may invoke any of a plurality of edit operations, depending on the target of the input.

Thus, various embodiments of the systems and methods disclosed herein may provide for multi-touch editing of graphical programs.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system configured to execute a graphical program according to an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method for editing a graphical program using multi-touch input;

FIG. 6 illustrates an exemplary graphical program, according to one embodiment;

FIGS. 7A-7G illustrate various exemplary multi-touch inputs, according to one embodiment; and

FIGS. 8A-11B illustrate exemplary pairs of graphical programs before/after respective multi-touch invoked edit operations have been performed, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

U.S. patent application Ser. No. 12/572,455, titled “Editing a Graphical Data Flow Program in a Browser,” filed Oct. 2, 2009.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program—A Software Program in which the program architecture is that of a directed graph specifying the flow of data through the program, and thus functions execute whenever the necessary input data are available. Data flow programs can be contrasted with procedural programs, which specify an execution flow of computations to be performed. As used herein “data flow” or “data flow programs” refer to “dynamically-scheduled data flow” and/or “statically-defined data flow”.

Graphical Data Flow Program (or Graphical Data Flow Diagram)—A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW VI is one example of a graphical data flow program. A Simulink block diagram is another example of a graphical data flow program.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Subset—in a set having N elements, the term “subset” comprises any combination of one or more of the elements, up to and including the full set of N elements. For example, a subset of a plurality of icons may be any one icon of the plurality of the icons, any combination of one or more of the icons, or all of the icons in the plurality of icons. Thus, a subset of an entity may refer to any single element of the entity as well as any portion up to and including the entirety of the entity.

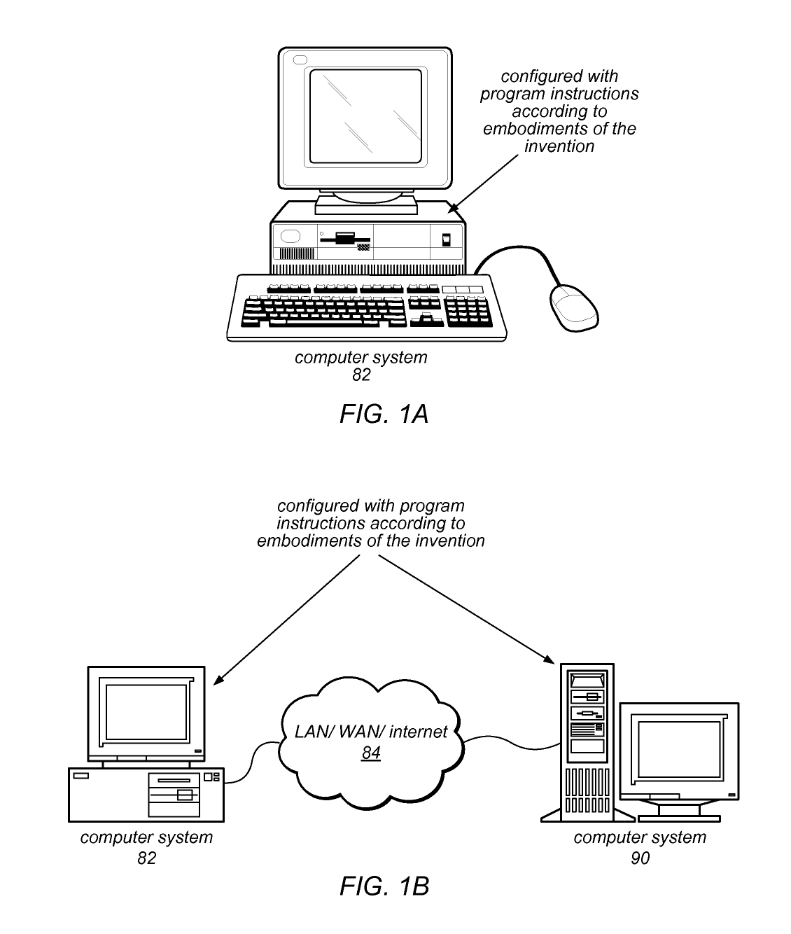

### FIG. 1A—Computer System

FIG. 1A illustrates a computer system 82 configured to implement embodiments of the invention. One embodiment of a method for editing a graphical program using multi-touch operations is described below.

As shown in FIG. 1A, the computer system 82 may include a display device configured to display the graphical program as the graphical program is created and/or executed. For example, the display device may display a graphical user interface (GUI) of a graphical programming development environment application used to create, edit, and/or execute such graphical programs. The graphical program development environment may be configured to utilize or support multi-touch edit (and possibly display) operations for developing graphical programs. The display device may also be configured to display a graphical user interface or front panel of the graphical program during execution of the graphical program. The graphical user interface(s) may comprise any type of graphical user interface, e.g., depending on the computing platform.

The computer system 82 may include at least one memory medium on which one or more computer programs or software components according to one embodiment of the present invention may be stored. For example, the memory medium may store one or more programs, e.g., graphical programs, which are executable to perform the methods described herein. Additionally, the memory medium may store a graphical programming development environment application used to create and/or execute graphical programs. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. In some embodiments, the graphical program development environment may be configured to operate in a distributed manner. For example, the development environment may be hosted or executed on the second computer system 90, while the GUI for the development environment may be displayed on the computer system 82, and the user may create and edit a graphical program over the network. In another embodiment, the development environment may be implemented as a browser-based application. For example, the user uses a browser program executing on the computer system 82 to access and download the development environment and/or graphical program from the second computer system 90 to create and/or edit the graphical program, where the development environment may execute within the user's browser. Further details regarding such browser-based editing of graphical programs are provided in U.S. patent application Ser. No. 12/572,455, titled “Editing a Graphical Data Flow Program in a Browser,” filed Oct. 2, 2009, which was incorporated by reference above.

The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

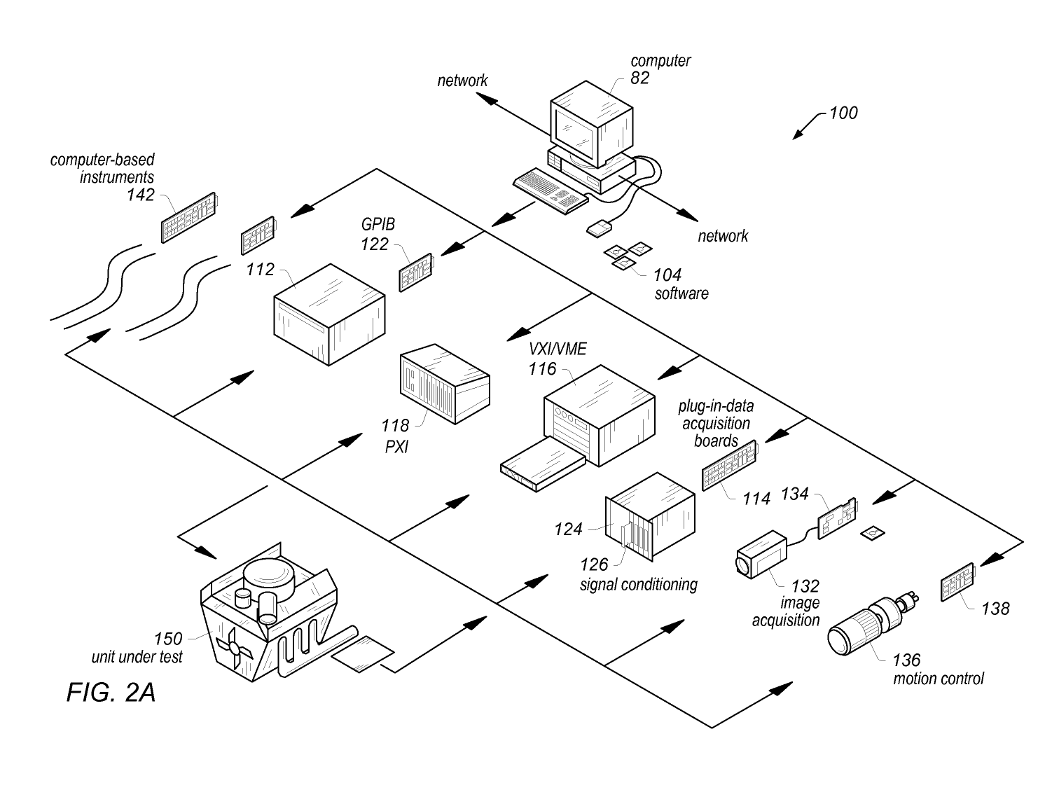

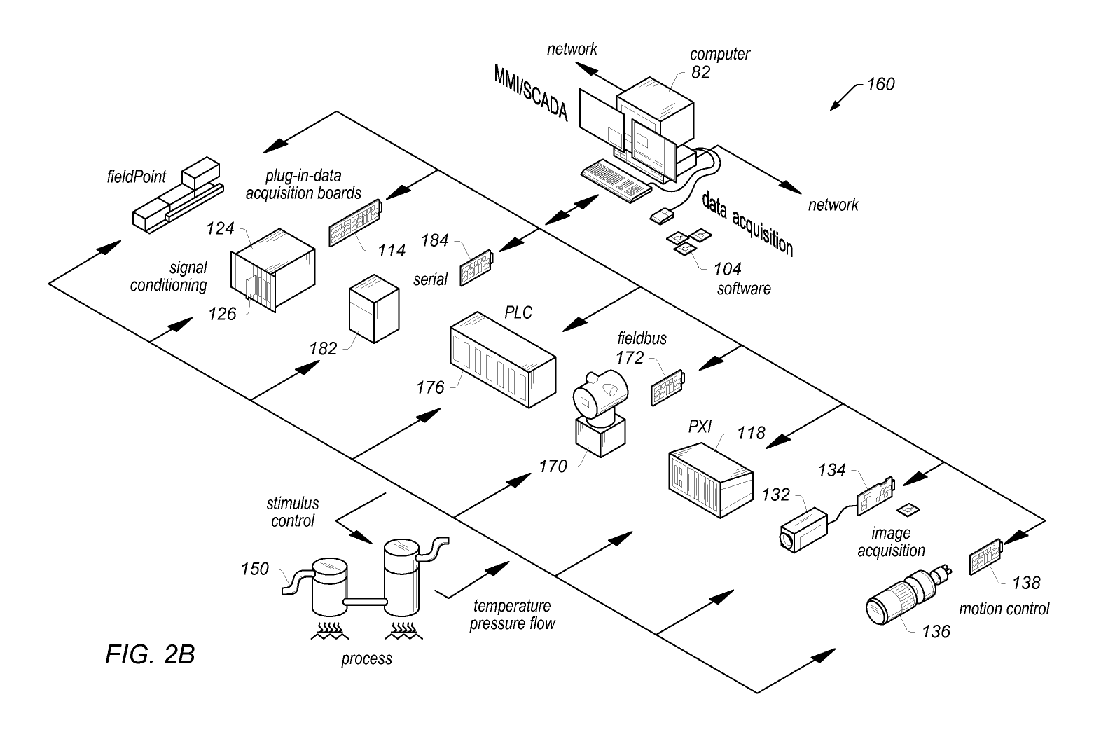

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to perform an automation function with respect to a process or device 150, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

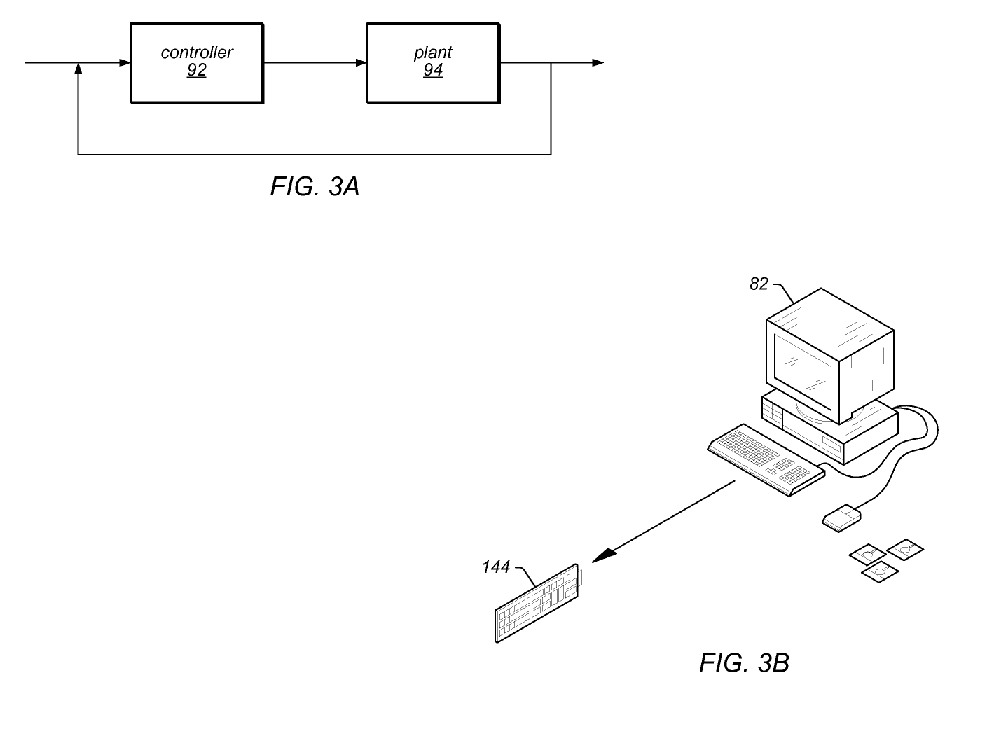

FIG. 3A is a high level block diagram of an exemplary system which may execute or utilize graphical programs. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

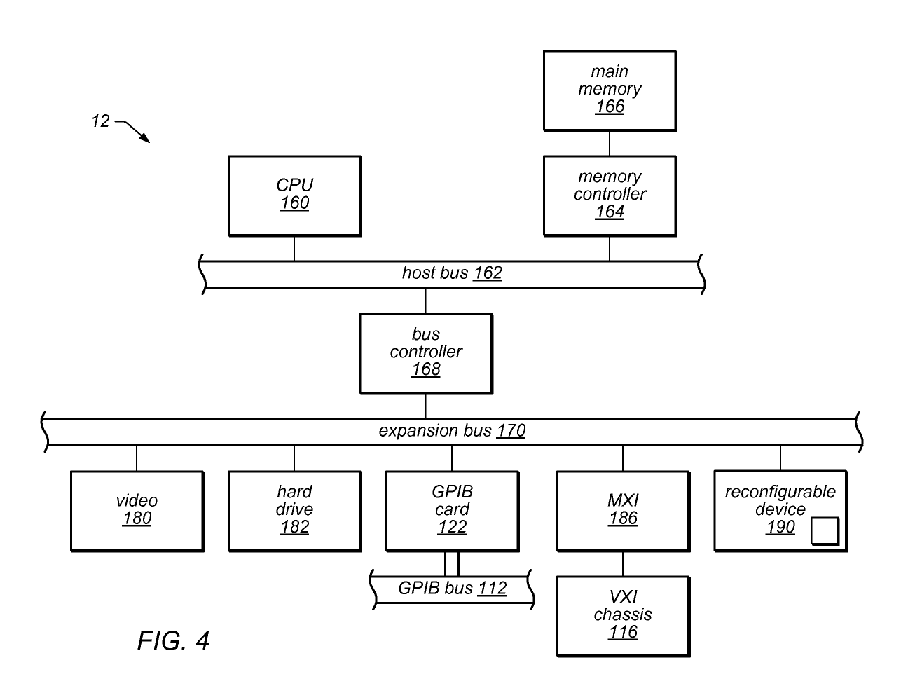

### FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the graphical program development environment configured to utilize or support multi-touch edit (and possibly display) operations, and graphical programs developed thereby. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170. The computer 82 may also comprise a GPIB card 122 coupled to a GPIB bus 112, and/or an MXI device 186 coupled to a VXI chassis 116.

As shown, a device 190 may also be connected to the computer. The device 190 may include a processor and memory which may execute a real time operating system. The device 190 may also or instead comprise a programmable hardware element. The computer system may be configured to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

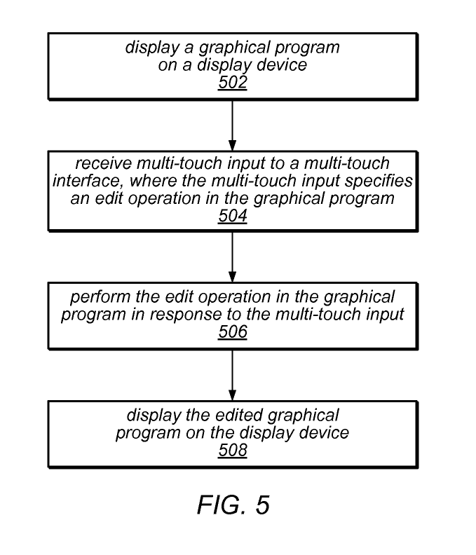

### FIG. 5—Flowchart of a Method for Editing a Graphical Program

FIG. 5 illustrates a method for edit a graphical program using multi-touch operations. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 502 a graphical program may be displayed on a display device, e.g., of the computer system 82 (or on a different computer system). The graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. As noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program. The graphical programming development environment may be configured to support multi-touch editing operations, as will be described in more detail below.

In an alternate embodiment, the graphical program may be created in 502 by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function that is desired to be performed by the instrument.

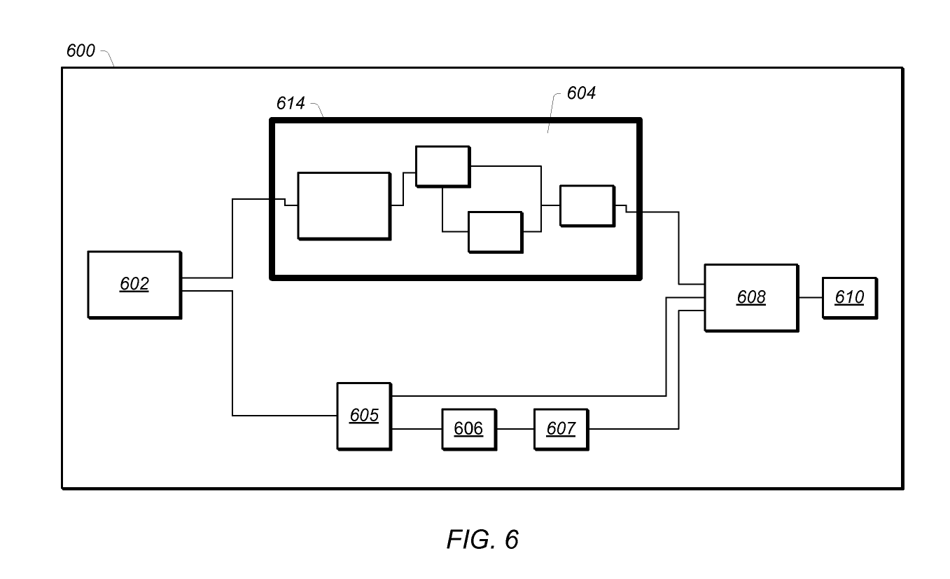

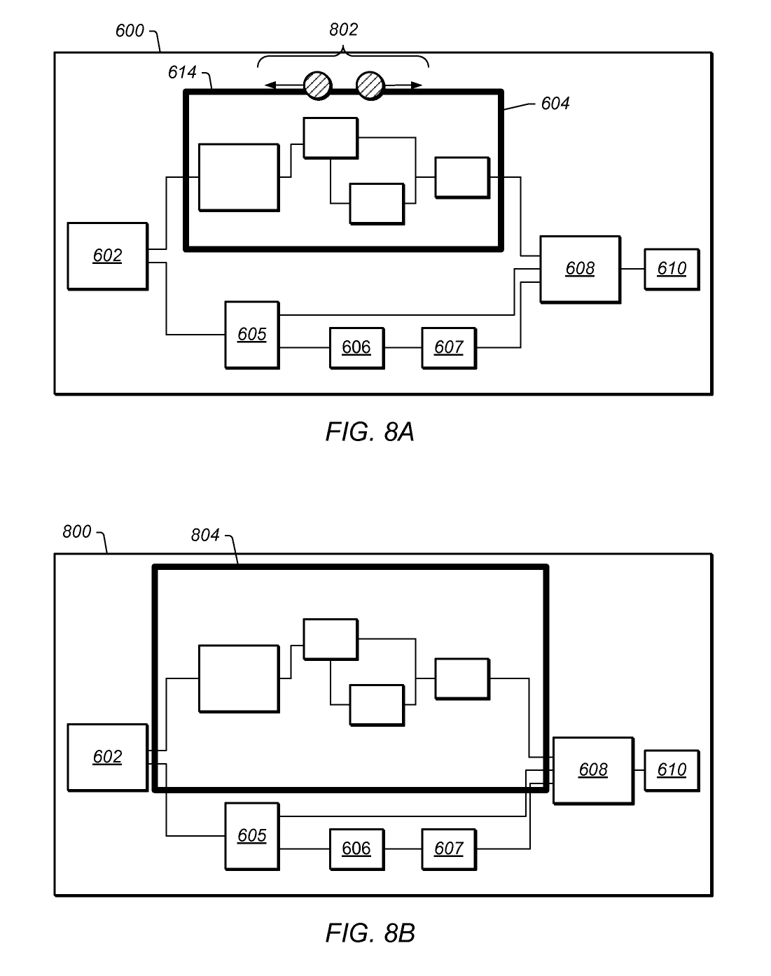

FIG. 6 illustrates an exemplary graphical program 600, according to one embodiment. As may be seen, this example graphical program includes various interconnected graphical program nodes, including a node or structure 614 that includes a frame containing graphical program elements 604 that are to be executed per the node's configuration. For example, in one embodiment, the structure 614 may be a loop node, e.g., a graphical FOR loop or graphical WHILE loop, that specifies that the contained graphical code is to be executed in an iterative manner. Other examples of nodes or structures with frames include a graphical case statement, a graphical sequence structure, and a graphical conditional structure, among others. The exemplary graphical program of FIG. 6, and variants thereof, will be used to illustrate various exemplary multi-touch inputs and corresponding (exemplary) edit operations, described below with reference to FIGS. 8A-11B.

In 504, multi-touch input may be received to a multi-touch interface, wherein the multi-touch input specifies an edit operation in the graphical program. As used herein, “multi-touch input” refers to user input to a multi-touch interface where there are multiple touchpoints active at the same time. In other words, the user may cause, utilize, or employ multiple simultaneous points of contact on the multi-touch interface. Note that the multi-touch interface may be a touch pad or a touch screen, as desired. In other words, the multi-touch interface may be or include a computer touch-pad and/or a computer touch-screen. Exemplary multi-touch input and edit operations are provided below.

In 506, the edit operation may be performed in the graphical program in response to the multi-touch input. In other words, the edit operation specified by the multi-touch input of 504 may be performed in or on the graphical program, thereby generating an edited graphical program.

In some embodiments, an indication of the multi-touch input may be displayed in the graphical program before or as the edit operation is performed. For example, each touchpoint may be indicated on the screen, e.g., by an icon, e.g., a dot, and whose size, color, or style, may be adjustable. Additionally, in some embodiments, additional graphical indicators related to the multi-touch input may be displayed. For example, in one embodiment, when the multiple touchpoints are first activated, e.g., prior to any movement, or possibly as the movement occurs, an indication of the associated edit operation may be displayed, e.g., arrows indicating movement options for moving the touchpoints. For example, in one illustrative embodiment, in a multi-touch pinching or reverse pinching input, once the touchpoints are active, but prior to any movement, radial double headed arrows may be displayed at each touchpoint, indicating that the touchpoints may be moved inwardly or outwardly to contract or expand an element or other portion of the program. Similarly, double headed arrows perpendicular to the radials, i.e., may indicate a rotational option or effect. In other words, such indicators may indicate movement options and/or edit effects resulting from such movements. The indicators may displayed in any number of ways, e.g., as dashed lines, with or without arrow heads, animation, etc., as desired.

In 508, the edited graphical program may be displayed on the display device. Said another way, the result of the edit operation may be indicated in the displayed graphical program.

In various embodiments, the multi-touch input may include any of various multi-touch operations, and the specified edit operation may be or include any of various graphical program edit operations.

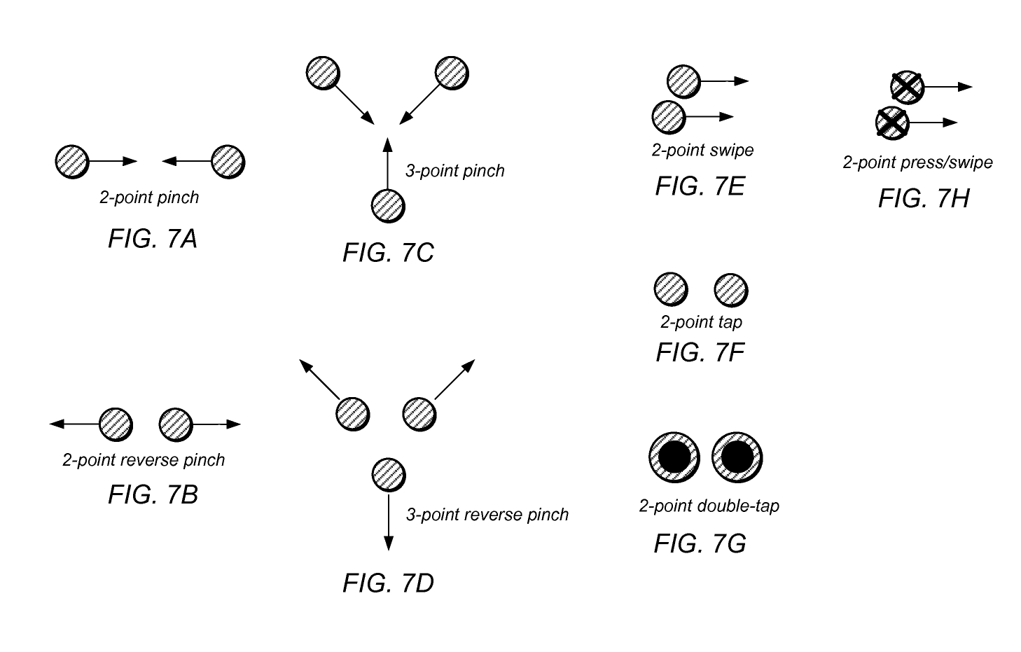

### FIGS. 7A-7G—Exemplary Multi-touch Input

FIGS. 7A-7G illustrate various exemplary multi-touch inputs, although it should be noted that the inputs shown are meant to be illustrative only, and are not intended to limit the multi-touch inputs to any particular set. Note that in these examples, and in the example figures described below, touchpoints are indicated by shaded circles, each representing an active point on a touch surface, movements are indicated by arrows, and double tapping is indicated by concentric circles.

For example, as shown, FIG. 7A illustrates a two-point pinching motion, whereas FIG. 7B illustrates a two-point reverse pinching motion. FIGS. 7C and 7D illustrate three-point pinching and reverse pinching, respectively, FIG. 7E illustrates a two-point swipe, where, for example, the user touches the touch surface at two points (simultaneously) and makes a sideways movement or gesture. FIGS. 7F and 7G illustrate two-point tapping and two-point double-tapping, respectively. As another example, FIG. 7H illustrates a multi-touch input comprising a 2-point press followed by a 2-point swipe, where the press is indicated with an “X” superimposed on the touch points. In other words, an “X” may indicate a “press”, as opposed to a “tap”. Other multi-touch inputs may be illustrated in a similar manner. For example a two-point triple-tap may be illustrated via three concentric circles per touch point, or arrows may indicate any of various directions, among others.

Below are described various exemplary multi-point inputs and graphical program edit operations, although it should be noted that the multi-point inputs and edit operations presented are exemplary only, and are not intended to limit the multi-point inputs and edit operations to any particular set of inputs and operations. Moreover, it should be further noted that any of the described multi-point inputs and edit operations may be used in any of various combinations as desired, and further, that any other multi-point inputs or edit operations are also contemplated. In other words, any multi-touch inputs (including sequences of such inputs) and any associated graphical program edit operations are considered to be within the scope of the invention described herein.

In some embodiments, the multi-touch input may specify or manipulate a graphical program element in the graphical program.

For example, the multi-touch input may be or include a pinching or reverse pinching motion applied to a graphical program element, and the edit operation may be or include resizing the graphical program element. For example, in embodiments where the graphical program element includes a frame for containing one or more other graphical program elements, e.g., a graphical FOR loop, a graphical case statement, a graphical sequence structure, a graphical conditional structure, and so forth, as represented by the element 614 in the graphical program of FIG. 6, the resizing of the graphical program element may include resizing the frame, e.g., to shrink or expand (respectively) the size of the frame to more effectively or efficiently contain the graphical program code contained therein. FIG. 8A illustrates application of a reverse pinch multi-touch input 802 applied to the node 614, according to one embodiment, and FIG. 8B illustrates an exemplary result of the corresponding edit operation 804, where the frame of the element 614 is shown expanded, e.g., to accommodate further nodes to be contained in the frame.

In one embodiment, the pinching or reverse pinching motion may have an orientation that specifies the direction of the resizing operation. For example, in resizing an element, such as a loop structure that includes a rectangular frame, a horizontally oriented motion may resize the frame only in the horizontal direction, a vertically oriented motion may resize the frame only in the vertical direction, and a diagonally oriented motion may resize the frame in both directions, e.g., proportionally. Note that in some embodiments, the particular angle of a diagonal-like orientation may specify a corresponding ratio in the resizing of the frame, i.e., may specify resizing in dimensional proportions per the angle.

Generalizing the above, in some embodiments, other multi-touch inputs may be modified by or may be sensitive to the direction or angle of one or more vectors related to the input. For example, in one embodiment of a two-point swipe input (see, e.g., FIG. 7E) to move or dismiss an element, the angle or direction of the swiping movement or “flick” (arrows) may specify the direction of movement, or even the operation performed on the element, e.g., flicking the element down may delete it from the program, whereas flicking the element upwards or sideways may move the element to a holding area or palette.

As another example, the multi-touch input may be or include two touchpoints applied respectively to two graphical program elements, and the edit operation may include wiring the two graphical program elements together. Thus, for example, the user may “touch” two graphical program nodes, e.g., with two fingers, a finger and thumb, etc., and the nodes may be automatically wired, i.e., connected for data flow.

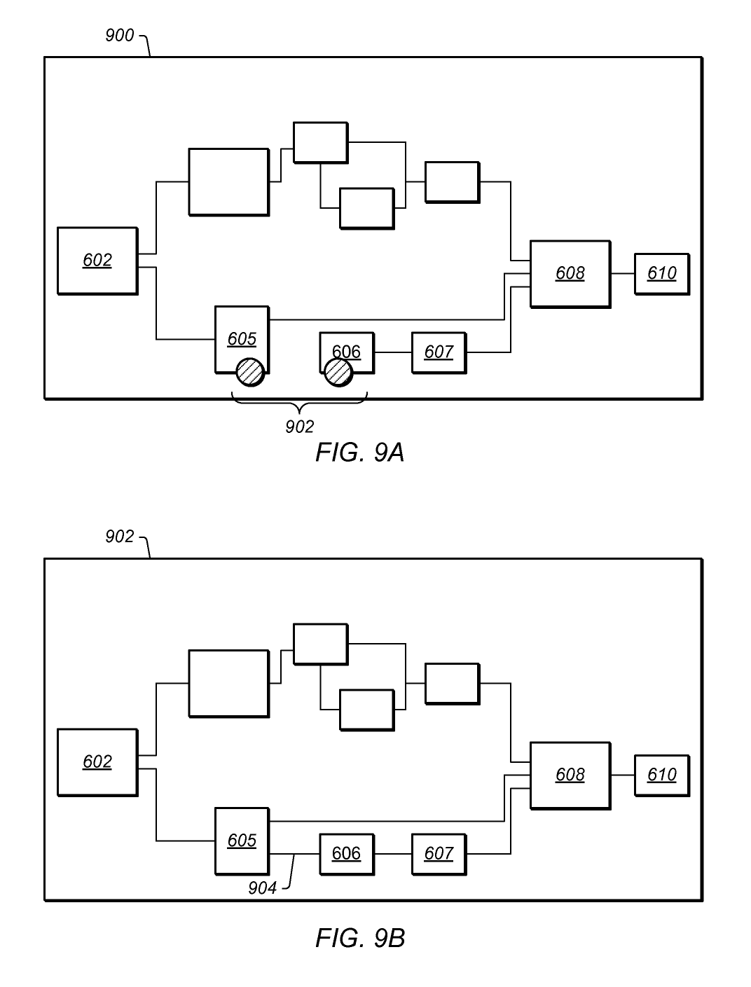

FIG. 9A illustrates an exemplary graphical program in which a two point multi-touch is applied to two graphical program elements 605 and 606 to invoke a connection between the two graphical program elements. FIG. 9B illustrates the resulting edited graphical program, with new connection 904 shown between the two elements. In some embodiments, the wiring may be performed in response to an indication provided in addition to the initial “touch”. For example, the connection may be made if the user remains touching the two elements for some duration, e.g., a second or more, or if the user makes a slight closing gesture, i.e., bringing the two touchpoints slightly closer, among others. In other words, the multi-touch input may involve additional aspects that complete or refine the specification of the edit operation.

Note that the above wiring operation is meant to be exemplary only, and that other multi-touch input may be used to accomplish such interconnection of graphical program elements. For example, in another embodiment, the multi-touch input may include double tapping two touchpoints applied respectively to two graphical program elements, and the edit operation may be or include wiring the two graphical program elements together. In other words, for example, the user may double tap on two graphical program nodes simultaneously, and the nodes may be automatically wired together in response.

In one embodiment, the multi-touch input may include two or more touchpoints applied respectively to two or more graphical program elements, and the edit operation may include selecting the two or more graphical program elements for a subsequent operation to be performed on the two or more graphical program elements. In other words, the multi-touch input may be used to select multiple graphical program elements at the same time, thus setting up for application of a subsequent operation to be applied to all or each of them, e.g., a move or “drag and drop” operation, deletion, etc. The selection of graphical program elements may be indicated visually in the displayed graphical program, e.g., by high-lighting the selected elements, or via any other visual technique desired.

As another example of a selection process, in one embodiment the multi-touch input may include three or more touchpoints defining a convex hull around one or more graphical program elements, and the edit operation may include selecting the one or more graphical program elements for a subsequent operation to be performed on the one or more graphical program elements. In other words, the multi-touch input may define a convex polygon, with each touchpoint defining a respective vertex, and any graphical program elements within may be selected.

Once an element (or elements) has been selected, multi-touch input may operate to manipulate the element(s). For example, the multi-touch input may be or include a rotation motion applied to one or more graphical program elements, and the resulting edit operation may include rotating the one or more graphical program elements. Thus, for example, the user may “tap” on one or more elements, or select one or more elements via the “convex hull” technique described above (or via any other means), then twist or rotate the touchpoints to cause a corresponding rotation of the element(s). In some embodiments, the rotation may be quantized, e.g., only specified values of rotation may be allowed, e.g., 90 degree orientations, among others.

In some embodiments, a graphical program node may represent another graphical program, e.g., a graphical subprogram, and multi-touch input may be used to expand or collapse the node to and from the graphical subprogram, e.g., to examine or edit the subprogram. In other words, the graphical program may include a graphical subprogram, where the graphical subprogram is represented by a graphical program node. Such a representative node may be referred to as a subVI. Multi-touch input may be used to switch back and forth between the node and its corresponding graphical subprogram, i.e., to expand the node to its corresponding subprogram, and to collapse the subprogram back to the node. Note that in some embodiments, the expansion may be in situ, i.e., the subprogram may be displayed in-place in the graphical program, i.e., may replace the node in the display of the graphical program, while in other embodiments, the display of the subprogram may be outside the graphical program, e.g., replacing the graphical program in the edit window, or in a different, e.g., newly spawned, edit window.

For example, in one exemplary embodiment, the multi-touch input may include tapping two or more touchpoints on a graphical program node that represents a graphical subprogram, and the edit operation may include expanding the graphical program node to the graphical subprogram. In a similar embodiment, the multi-touch input may include double tapping two or more touchpoints on a graphical program node that represents a graphical subprogram, and the edit operation may include expanding the graphical program node to the graphical subprogram. These techniques may also be used to collapse a graphical subprogram back to its corresponding or representative graphical program node, e.g., by multi-touch tapping or double tapping on the graphical subprogram, e.g., on the border or frame of the subprogram, e.g., by multi-touch tapping or double tapping on opposite corners of the subprogram, and so forth.

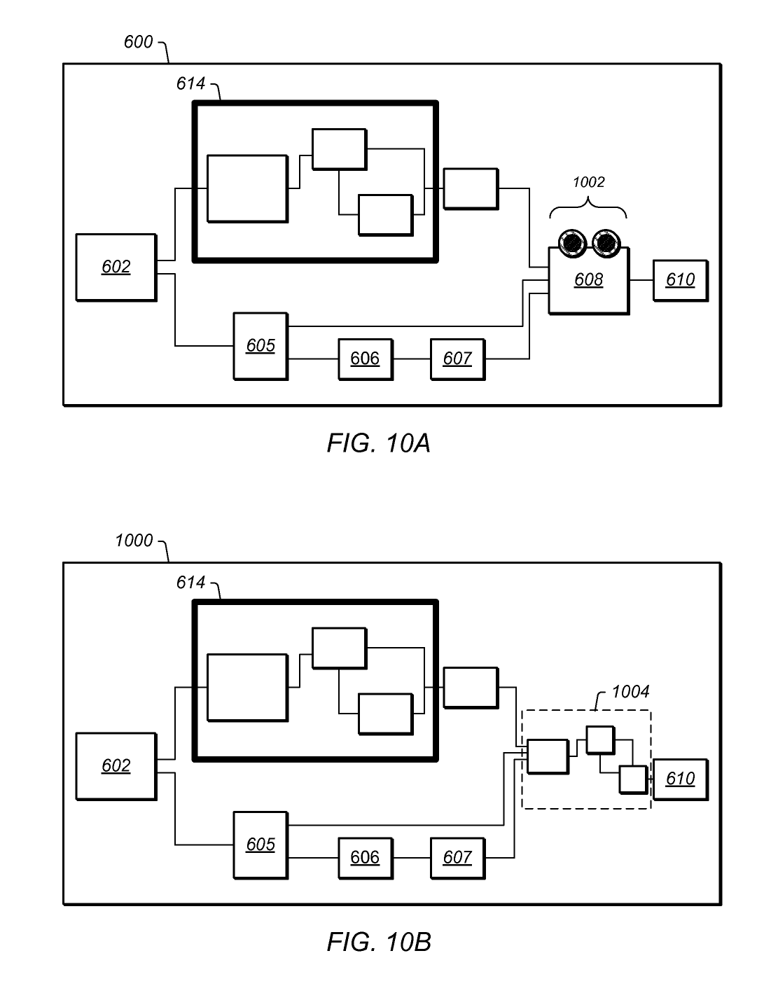

FIG. 10A illustrates an exemplary graphical program in which graphical program element (node) 608 is a subprogram node (e.g., a subVI) to which a two-touch double tap multi-touch input 1002 is applied. FIG. 10B illustrates the same graphical program, but where the graphical program element 608 has been expanded in situ to its corresponding block diagram 1004.

Alternatively, or additionally, in another exemplary embodiment, the multi-touch input may include a reverse pinching motion applied to a graphical program node that represents a graphical subprogram, and the edit operation may include expanding the graphical program node to the graphical subprogram. Conversely, the multi-touch input may include a pinching motion applied to a graphical subprogram, and the edit operation may include collapsing the graphical subprogram to its representative graphical program node.

In a further embodiment, the multi-touch input may include a multi-touch swipe applied to a graphical program node (that represents a graphical subprogram), and the edit operation may include expanding the graphical program node to the graphical subprogram. Conversely, the multi-touch input may include a multi-touch reverse swipe applied to a graphical subprogram, and the edit operation may include collapsing the graphical subprogram to the representative graphical program node.

In other embodiments, any other multi-touch input may be used to expand or collapse subprograms and their nodes, as desired, the above techniques being exemplary only.

In another exemplary embodiment, the multi-touch input may include a reverse pinching motion applied to a graphical program node, and the edit operation may include increasing the graphical program node in size with respect to other nodes in the graphical program. In other words, the edit operation may magnify the node (icon) in-place. This may be useful when the node icon is highly detailed, or when the display resolution is high, but the icon size is small. Conversely, the multi-touch input may include a pinching motion applied to a graphical program node, and the edit operation may include decreasing the graphical program node in size with respect to other nodes in the graphical program.

In some embodiments, this “magnification” of the graphical program node may be combined with the above expansion operation applied to nodes that represent graphical subprograms. For example, in an embodiment where the node represents a graphical subprogram, the edit operation may magnify the node up to some specified size or ratio, after which the node may be automatically expanded to its corresponding graphical subprogram, and conversely, the reverse pinching motion may collapse the subprogram to the node, then shrink the node.

In a related embodiment, multi-touch input, e.g., reverse pinching, multi-touch tap or double tap, etc., may be used to invoke expansion of a graphical case/switch node, where expanding the node (possibly displaying the top case) may result in display of all the cases, e.g., side by side, as a grid, etc. Conversely, multi-touch pinching may collapse the cases back to the node (e.g., top case).

In a further embodiment, the multi-touch input may include a multi-touch “flick”, where the user touches an element with two or more digits and flicks the element in some direction. The edit operation may include moving the flicked element in the direction of the flick. For example, in one embodiment, the rate or speed of the flicking motion may determine the distance the element moves. In some embodiments, the elements may be given an inertia/friction-like property, where, as the element moves, it slows down until coming to rest. In other embodiments, the multi-touch flick may invoke other edit operations. For example, in one embodiment, flicking the element may delete it from the graphical program. In another embodiment, flicking an element may send it to a temporary holding area or palette. For example, the user may wish to use the element, but may not wish to clutter the current edit area at the moment. Once the user is ready to use the element, it may be retrieved from the area or palette. This may allow a user to set an element aside for later use while retaining any configuration applied to that element.

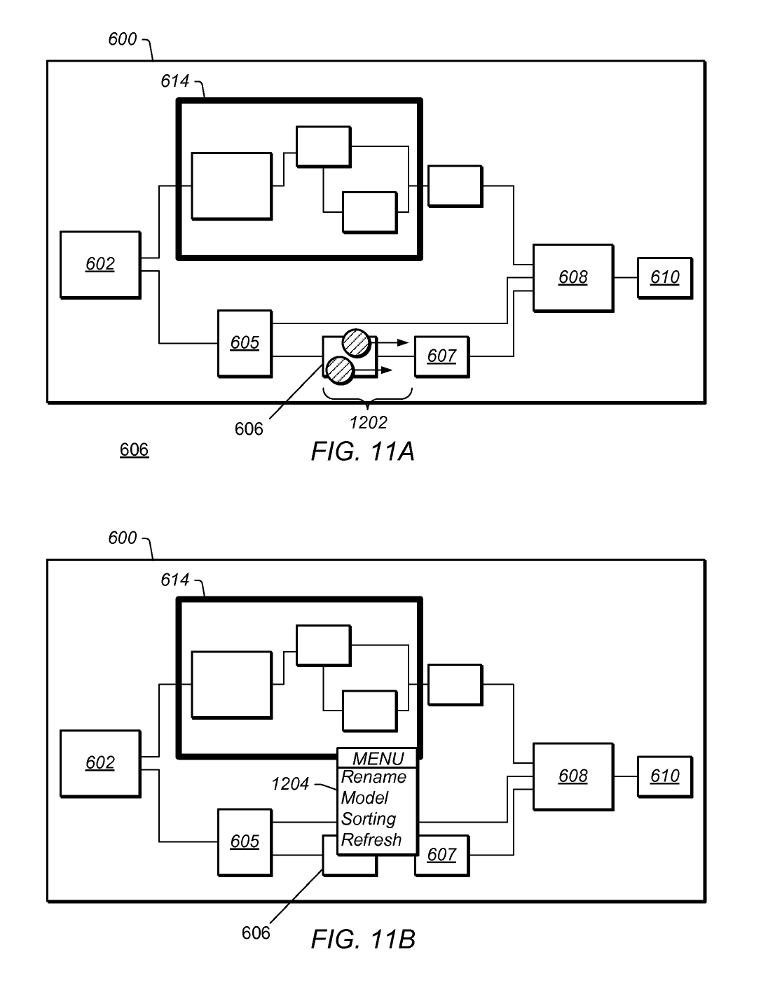

In another embodiment, the multi-touch input may include a multi-touch swiping movement applied to a graphical program element, e.g., a node (or region, etc.), and the edit operation may include invoking a display of selectable operations applicable to the element, e.g., may invoke a pop-up menu or palette, similar to a “right-click” with a pointing device. FIG. 11A illustrates a two-touch swipe 1202 applied to graphical program element 606 to invoke a pop-up menu for the element, and FIG. 11B illustrates display of the invoked menu, whereby the user may configure or otherwise operate on the graphical program element.

As another example, in one embodiment, the multi-touch input may include a press/hold/swipe gesture on a node, e.g., the user may press two fingers on a node, wait some specified period of time, and then swipe the fingers without releasing on the node, which may invoke a different operation than a standard two finger swipe on the node, e.g., may invoke a context menu or perform some other manipulation of the node.

In some embodiments, the multi-touch input may be context sensitive, where the edit operation is based at least partially on a target graphical program element or region to which the multi-touch input is applied. In other words, the edit operation invoked by the multi-touch input may depend on the particular element(s) of the graphical program to which the input is applied, including blank space in the program. Thus, for example, tapping two graphical program elements simultaneously may invoke a wiring operation to connect the two elements, whereas tapping a single graphical program element may simply select that element, e.g., for a subsequent operation. In this manner, a given multi-touch input may invoke any of a plurality of edit operations, depending on the target of the input.

For example, as noted above, the multi-touch input may specify or manipulate a region in the graphical program. In one embodiment, the multi-touch input may include a pinching or reverse pinching motion (with two or more simultaneous touchpoints) applied to a region in the graphical program, and the edit operation may include resizing the region in the graphical program. This may be useful, for example, for inserting additional elements into an existing program. In one embodiment, resizing the region may displace one or more other graphical program elements or regions in the graphical program. In other words, expanding a region may cause graphical program elements proximate to the original region to be moved outward to make room for the expanded region. Of course, the movement of these “peripheral” elements may result in movement of additional elements, where the effect may ripple outward until the graphical program elements are appropriately arranged. Conversely, in an embodiment where a region has been shrunk (or where one or more elements have been deleted), elements surrounding the original region may be adjusted accordingly, e.g., moved into the region, etc.

In further embodiments, the multi-touch input may be combined with additional or auxiliary input to specify other edit operations. For example, in one embodiment, the multi-touch input may be performed in combination with a keyboard key press to form a combination multi-touch input, and the edit operation invoked by the combination multi-touch input may be different from that invoked by the multi-touch input alone. Moreover, the same multi-touch input may be combined with different key presses to invoke different respective edit operations.

Note that the various combinations of multi-touch inputs, key presses (possibly including multiple keys, e.g., “control-shift-pinching motion”), and context, provides a great number of distinct input/edit operation pairings whereby a wide variety of edit operations may be performed on a graphical program. Moreover, in some embodiments, one or more of the particular pairings may be user configurable. For example, a GUI may be provided whereby the user may select from all available multi-touch inputs, including available auxiliary inputs, and may associate the selection with any available edit operations, as desired. As an example of such configuration, the user may specify whether a particular multi-touch swipe associated with a specified edit operation is a left-to-right swipe or a right-to-left swipe. Any other aspects of the inputs and/or edit operations may be configurable as desired.

It should also be noted that in various embodiments, further distinctions may be made (and possibly configured) regarding the particular number of simultaneous touchpoints involved in the multi-touch input. For example, a two-touchpoint pinching motion may be distinct from a three- or a four-touchpoint pinching motion. Moreover, in further embodiments, the relative positions of the multiple touchpoints may be interpreted as distinct inputs. For example, a three-touchpoint input where the three touchpoints are spread out may be interpreted differently from one in which two of the three touchpoints are close together and the third is spread out. Thus, for example, a pinching (or reverse pinching) move with two fingers together and another finger separate from them on a node or structure may operate to change the scale of the node or structure relative to the other nodes on the diagram, whereas a similar motion but where the three fingers are roughly equidistant may invoke some other edit function, e.g., may zoom the entire block diagram.

Such distinctions, and their configurability, may thus further expand the palette of multi-touch inputs available for use in editing or otherwise manipulating graphical programs.

In some embodiments, multi-touch input may be used to control display of the graphical program, i.e., to control graphical program display operations. In other words, multi-touch input may be received to the multi-touch interface, where the multi-touch input specifies a display operation for the graphical program. The display operation for the graphical program may be performed in response to the other multi-touch input, and the graphical program may be displayed in accordance with the display operation.

Thus, for example, in one embodiment, the multi-touch input may include a multi-touch swiping move, e.g., a multi-finger swipe, and the display operation may include scrolling the graphical program. For example, swiping to the right may cause the block diagram to move to the right in the display window, thus scrolling left (or vice versa). Note that in some embodiments, the swiping and resultant scrolling needn't be orthogonal to the window frame. In other words, in some embodiments, a forty-five degree swipe may result in a commensurate, e.g., forty-five degree, motion or scrolling operation. This feature may be particularly useful for easily navigating large (2-dimensional) block diagrams.

In another exemplary embodiment, the multi-touch input may include a pinching or reverse pinching motion (using two or more digits) applied to a region in the graphical program, and the edit operation may include zooming display of the graphical program out or in. Thus, for example, in one embodiment, to zoom in or magnify the display of the graphical program, the user may touch the touch-surface (multi-touch interface) with two or more fingers or digits bunched together, then spread them to invoke the zoom operation. Conversely, the user may touch the touch-surface with two or more fingers or digits (or other touch implements) spread, then draw them together to zoom out or reduce the image of the graphical program.

It should be noted that in various embodiments, the multi-touch input may be performed with two or more digits from a single hand, from two hands, e.g., two index fingers, or even from multiple users, or, instead of fingers, may be performed via multiple styluses (styli), or a combination of both, as desired. In other words, the multi-touch input may be from any sources desired. Note, too, that as used herein, the term “finger” may refer to any digit, e.g., may include the thumb.

Additionally, in some embodiments, multiple multi-touch edit sessions may be performed simultaneously on a single graphical program. For example, in an embodiment where a large graphical program is displayed and edited on a multi-user touch-sensitive work surface, such as a touch-table/display, multiple users may apply various of the above described inputs and operations at the same time, where the table localizes each user's inputs, e.g., based on geometrical considerations, and thus operates as multiple independent editors operating on the same program.

Thus, various embodiments of the systems and methods disclosed herein may provide for multi-touch editing of graphical programs.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-accessible memory medium that stores program instructions executable by a processor to implement:
displaying a graphical program on a display device, wherein the graphical program comprises a plurality of interconnected nodes that visually indicate functionality of the graphical program;
receiving multi-touch input to a multi-touch interface, wherein the multi-touch input specifies an edit operation in the graphical program;
performing the edit operation in the graphical program in response to the multi-touch input; and
displaying the edited graphical program on the display device.

2. The computer-accessible memory medium of claim 1, wherein the multi-touch input specifies or manipulates a graphical program element in the graphical program.

3. The computer-accessible memory medium of claim 1,
wherein the multi-touch input comprises a pinching or reverse pinching motion applied to a graphical program element; and
wherein the edit operation comprises resizing the graphical program element.

4. The computer-accessible memory medium of claim 3,
wherein the graphical program element comprises a frame for containing one or more other graphical program elements, and wherein said resizing the graphical program element comprises resizing the frame.

5. The computer-accessible memory medium of claim 1,
wherein the multi-touch input comprises two touchpoints applied respectively to two graphical program elements; and
wherein the edit operation comprises wiring the two graphical program elements together.

6. The computer-accessible memory medium of claim 1,
wherein the multi-touch input comprises double tapping two touchpoints applied respectively to two graphical program elements; and
wherein the edit operation comprises wiring the two graphical program elements together.

7. The computer-accessible memory medium of claim 1,
wherein the multi-touch input comprises two or more touchpoints applied respectively to two or more graphical program elements; and
wherein the edit operation comprises selecting the two or more graphical program elements for a subsequent operation to be performed on the two or more graphical program elements.

8. The computer-accessible memory medium of claim 1,
wherein the multi-touch input comprises three or more touchpoints defining a convex hull around one or more graphical program elements; and
wherein the edit operation comprises selecting the one or more graphical program elements for a subsequent operation to be performed on the one or more graphical program elements.

9. The computer-accessible memory medium of claim 1,
wherein the multi-touch input comprises a rotation motion applied to one or more graphical program elements; and
wherein the edit operation comprises rotating the one or more graphical program elements.

10. The computer-accessible memory medium of claim 1,
wherein the graphical program includes a graphical subprogram, wherein the graphical subprogram is represented by a graphical program node in the graphical program;
wherein the multi-touch input comprises tapping or double tapping two or more touchpoints on the graphical program node; and
wherein the edit operation comprises expanding the graphical program node to the graphical subprogram.

11. The computer-accessible memory medium of claim 1,
wherein the graphical program includes a graphical subprogram, wherein the graphical subprogram is represented by a graphical program node in the graphical program;
wherein the multi-touch input comprises tapping or double tapping two or more touchpoints on the border of the graphical subprogram; and
wherein the edit operation comprises collapsing the graphical subprogram to the representative graphical program node.

12. The computer-accessible memory medium of claim 1,
wherein the graphical program includes a graphical subprogram, wherein the graphical subprogram is represented by a graphical program node in the graphical program;
wherein the multi-touch input comprises a reverse pinching motion applied to the graphical program node; and
wherein the edit operation comprises expanding the graphical program node to the graphical subprogram.

13. The computer-accessible memory medium of claim 1,
wherein the graphical program includes a graphical subprogram, wherein the graphical subprogram is represented by a graphical program node in the graphical program;
wherein the multi-touch input comprises a pinching motion applied to the graphical subprogram; and
wherein the edit operation comprises collapsing the graphical subprogram to the representative graphical program node.

14. The computer-accessible memory medium of claim 1,
wherein the graphical program includes a graphical subprogram, wherein the graphical subprogram is represented by a graphical program node in the graphical program;
wherein the multi-touch input comprises a multi-touch swipe applied to the graphical program node; and
wherein the edit operation comprises expanding the graphical program node to the graphical subprogram.

15. The computer-accessible memory medium of claim 1,
wherein the graphical program includes a graphical subprogram, wherein the graphical subprogram is represented by a graphical program node in the graphical program;
wherein the multi-touch input comprises a multi-touch reverse swipe applied to the graphical subprogram; and
wherein the edit operation comprises collapsing the graphical subprogram to the representative graphical program node.

16. The computer-accessible memory medium of claim 1,
wherein the multi-touch input comprises a reverse pinching motion applied to a graphical program node; and
wherein the edit operation comprises increasing the graphical program node in size with respect to other nodes in the graphical program.

17. The computer-accessible memory medium of claim 1,
wherein the multi-touch input comprises a pinching motion applied to a graphical program node; and
wherein the edit operation comprises decreasing the graphical program node in size with respect to other nodes in the graphical program.

18. The computer-accessible memory medium of claim 1,
wherein the multi-touch input comprises a multi-touch swiping movement applied to a graphical program element; and
wherein the edit operation comprises invoking a display of selectable operations applicable to the element.

19. The computer-accessible memory medium of claim 1,
wherein the multi-touch input is context sensitive, wherein the edit operation is based at least partially on a target graphical program element or region to which the multi-touch input is applied.

20. The computer-accessible memory medium of claim 1, wherein the multi-touch input specifies or manipulates a region in the graphical program.

21. The computer-accessible memory medium of claim 20,
wherein the multi-touch input comprises a pinching or reverse pinching motion applied to a region in the graphical program; and
wherein the edit operation comprises resizing the region in the graphical program; and
wherein said resizing the region displaces one or more other graphical program elements or regions in the graphical program.

22. The computer-accessible memory medium of claim 1, wherein the multi-touch interface comprises a computer touch-pad.

23. The computer-accessible memory medium of claim 1, wherein the multi-touch interface comprises a computer touch-screen.

24. The computer-accessible memory medium of claim 1,
wherein the multi-touch input is performed in combination with a keyboard key press to form a combination multi-touch input; and
wherein the edit operation invoked by the combination multi-touch input is different from that invoked by the multi-touch input alone.

25. A computer-implemented method for creating a graphical program, the method comprising:
utilizing a computer to perform:
displaying a graphical program on a display device, wherein the graphical program comprises a plurality of interconnected nodes that visually indicate functionality of the graphical program;
receiving multi-touch input to a multi-touch interface, wherein the multi-touch input specifies an edit operation in the graphical program;
performing the edit operation in the graphical program in response to the multi-touch input; and
displaying the edited graphical program on the display device.
